(19) United States
(12) Patent Application Publication
(10) Pub. No.: US 2009/0265780 A1
(43) Pub. Date: Oct. 22, 2009

(54) ACCESS EVENT COLLECTION

(75) Inventors: Ohad Korkus, Tel-Aviv (IL); Yakov Faitelson, Elkana (IL); Ophir Kretzer, Reut (IL); David Bass, Beit-Hashmonai (IL); Yizhar Keysar, Kochav Yair (IL)

Correspondence Address: DARBY & DARBY P.C., P.O. BOX 770, Church Street Station, New York, NY, 10008-0770, US

(73) Assignee: Varonis Systems Inc., New York, NY (US)

(21) Appl. No.: 12/106,466

(22) Filed: Apr. 21, 2008

(51) Int. Cl. G06F 21/00

(52) U.S. Cl. 726/22

(57) ABSTRACT

On-line and computationally efficient methods and systems are provided for back resolving path names of files from inode numbers during data access request processing. As a result, a near real-time recording of data access events is achieved, including identification of the user who performed the access, and the full path name of the data object that was accessed. In a typical application, access events are collected for use in access control of storage elements in complex organizational file systems.

### BACKGROUND OF THE INVENTION

1. Field of the Invention

This invention relates to computer security. More particularly, this invention relates to monitoring of file access using an operating system that lacks optimal native file identification capabilities.

2. Description of the Related Art

Data security policies typically determine who has access to an organization's stored data on various computer systems. These policies are rarely static. Users from within the organization, e.g., employees, partners, contractors, can pose a threat as severe as threats from outside the organization. Thus, as the structure and personnel makeup of the organization change, the security policy should be adjusted from time to time. Yet, information technology departments often find it difficult to manage user access rights and to ensure that needed information is conveniently available, while still protecting the organization's sensitive data.

Large business organizations may operate enterprise computer systems comprising large numbers of servers, often geographically distributed. Storage elements in these systems may be accessible in many combinations by large numbers of users, possibly numbering in the hundreds of thousands. Various personnel associated with data access authorizations, including information technology personnel, operational personnel such as account managers, and third-party reviewers such as the legal department of the enterprise, may need to routinely inquire as to user access rights to enterprise data.

### SUMMARY OF THE INVENTION

Access control technologies have not been optimally implemented in enterprises that utilize diverse access control models. The state of the art today is such that there is no easy way for system administrators to know who is capable of accessing what in such environments. As a result, in many organizations an unacceptably high proportion of users has incorrect access privileges. The related problems of redundant access rights and orphan accounts of personnel who have left the organization have also not been fully solved. Hence, there is a need for improvements in identifying and controlling user file permissions in order to improve data security, prevent fraud, and improve company productivity. Furthermore, misuse of data access, even by authorized users, is a concern of those charged with simplification and automation of system security. These functions require rapid identification of files being accessed. However, some operating systems, notably Unix®, fail to reveal adequate file identification information to applications when processing data access requests.

A disclosed embodiment of the invention provides an on-line and computationally efficient method for back-resolving the path name of files from index node identification obtained from the operating system. In environments in which the principles of the invention are applied, the operating system kernel converts a path name into an inode number before accessing the associated file. By capturing the path name and inode number in a near-concurrent manner, a meaningful near real-time recording of data access events is achieved. The record includes an identification of the user who requested the access.

In one aspect of the invention a probe engine monitors and logs current access events that are processed by the kernel, including the operation of converting a pathname into a Unix inode number. The correspondence between the inode and pathname, file attributes contained in the inode, and the user's identity with respect to each file access then become available to a higher-level application, which applies the information for its own purposes, typically data access management and computer security.

An embodiment of the invention provides a method of monitoring data accesses in a computer system, which is carried out by concurrently executing a monitor program and a kernel program. The kernel program services requests for data accesses in a file system that include index nodes that respectively index descriptors of computer files. The method is further carried out by using the kernel program to detect a request for access to one of the computer files, the request including a full path name of the requested file, and using the monitor program to obtain the full path name. The method is further carried out by using the kernel program to process the request by determining the identifier of the index node that corresponds to the requested computer files, and executing the request using the identifier. The method is further carried out while processing the request using the monitor program to obtain the identifier, memorize the full path name and the identifier as an entry in a log file, and accessing the log file for analysis of the requests for data access.

A further aspect of the method includes using the monitor program to identify an originator of the request, and including an identifier of the originator in the entry in the log file.

One aspect of the method includes outputting at least a portion of the log file to a display, and responsively to the contents of the log file, modifying privileges of the originator to access the file system.

Another aspect of the method includes accepting a second identifier of one of the index nodes, establishing that the identifier in the entry of the log file matches the second identifier, responsively thereto, retrieving the full path name from the entry, and reporting the full path name.

According to still another aspect of the method, the index nodes are inodes.

According to yet another aspect of the method, the index nodes are vnodes.

Other embodiments of the invention provide computer software product and apparatus for carrying out the above-described method.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram of a data processing system, wherein data access control policies are automatically defined and managed in accordance with a disclosed embodiment of the invention;

FIG. 2 is a flow chart of a method of monitoring file access operations to obtain a path name of a file and an inode number in accordance with a disclosed embodiment of the invention; and

FIG. 3 is a flow chart of a method of back-resolving an inode number to obtain a path name, in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client/server environment, such software programming code may be stored on a client or a server. The software programming code may be embodied on any of a variety of known tangible media for use with a data processing system, such as a diskette, or hard drive, or CD-ROM. The code may be distributed on such media, or may be distributed to users from the memory or storage of one computer system over a network of some type to storage devices on other computer systems for use by users of such other systems.

### Overview.

One aspect of the invention is directed to improvements in the rapid identification of storage elements being accessed in a file system. In one application, detected accesses are accumulated by a specialized access privilege management system, which is adapted for automatically defining and managing data access control policies, based in part on historical accesses to data. Such a data processing system is disclosed in commonly assigned U.S. Patent Application Publication No. 2006/0277184, entitled “Automatic Management of Storage Access Control”, which is herein incorporated by reference. However, a brief description will facilitate understanding of the present invention.

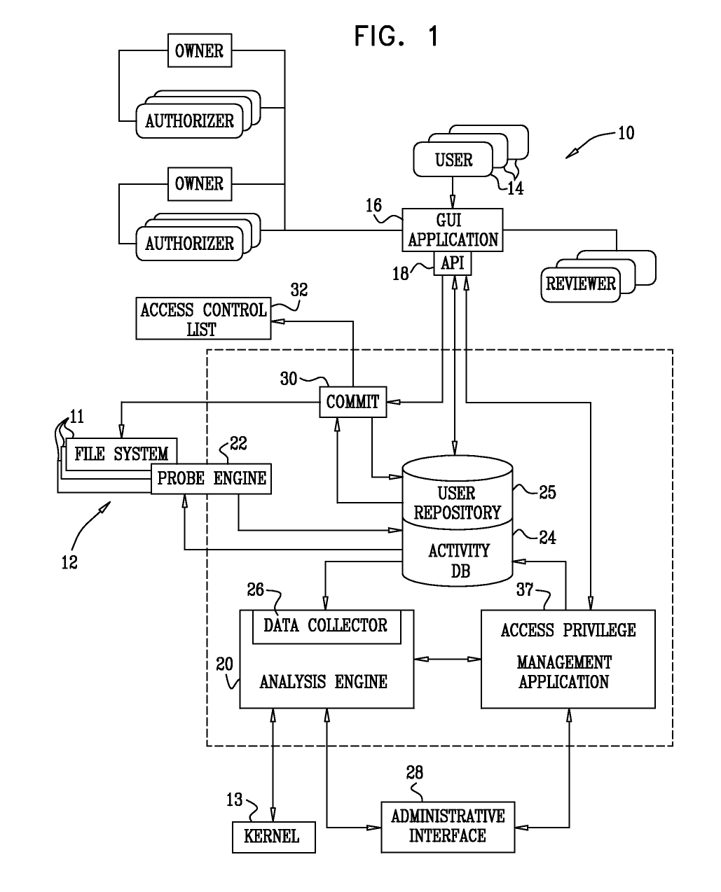

Turning now to the drawings, reference is initially made to FIG. 1, which is a block diagram of a data processing system 10, wherein data accesses are automatically detected, accumulated and submitted for processing in accordance with a disclosed embodiment of the invention. The system 10 is a version of the management system described in the above-noted U.S. Patent Application Publication No. 2006/0277184, modified to incorporate the principles of the present invention. The system 10 is a typical application of the inventive principles, and may be implemented as a general purpose computer having a memory for storing programs and data objects for performing the functions described below. Alternatively, the system 10 may be implemented using a plurality of computers and memories linked together in a network, for example the Internet.

Organization-wide data storage accessible by the system 10 and its users 14 is represented by an organizational file system 12. The organizational file system 12 may comprise one or more co-located storage units, or may be a geographically distributed data storage system, as is known in the art. The storage units are represented in FIG. 1 as filers 11. There is no requirement that individual storage units of the organizational file system 12 have the same capabilities.

The organizational file system 12 may be accessed by any number of users 14, using a graphical user interface application 16 (GUI) and a conventional display (not shown). The graphical user interface application 16 relates to other elements of the system 10 via an application programming interface 18 (API). The users 14 are typically members of the organization, but may also include outsiders, such as customers. The graphical user interface application 16 is the interface of the management system, which presents usage analysis, as determined an analysis engine 20.

A probe engine 22 is designed to collect access information from the organizational file system 12 in an ongoing manner, filter out duplicate or redundant information units and store the resulting information stream in a database 24. In addition to detecting actual accesses by the users 14, the probe engine 22 obtains the organization's current file security policy, the current structure of the organizational file system 12, and information about the users 14. While the probe engine 22 can be implemented in various environments and architectures, implementations on Unix and Unix-like systems are particularly relevant to the present invention. Aspects of the probe engine 22 relating to identification and collection of user access information are described in further detail hereinbelow.

The analysis engine 20 is a specialized module that is involved with security policy management. The front end for the analysis engine 20 is a data collector 26, which efficiently records the storage access activities in the database 24. The output of the analysis engine 20 can be further manipulated using an interactive administrative interface 28 that enables system administrators to perform queries on the collected data and to adjust user privileges via an access privilege management application 37, which may invoke the graphical user interface application 16.

Related to the analysis engine 20 is a commit module 30, which verifies a proposed security policy, using data collected prior to its implementation. The commit module 30 references an access control list 32 (ACL).

Efficient operation of the system 10, including operation of the access privilege management application 37 requires (1) detection of user file access; and (2) rapid and meaningful identification of the full path name of the particular storage element accessed and the user performing the access.

Some operating systems, notably UNIX, including particular versions, such as Solaris®, process file access requests in a kernel 13, but do not make sufficient details available to applications such as the system 10 as would satisfy its requirements. When a file access is detected, redirected virtual file system calls, described below, return a value known as an “inode number”, which is unique within each of the filers 11 of the organizational file system 12. UNIX also treats directories as files. Thus directories, like data files, possess inode numbers. The discussion that follows is also applicable generally to vnodes. A vnode is a modification of the Unix inode, as described in the document, Vnodes: An Architecture for Multiple File System Types in Sun Unix, S. R. Kleiman, USENIX Association: Summer Conference Proceedings, Atlanta, 1986, which is herein incorporated by reference.

The inode number identifies a data structure associated with the types of files accessible to ordinary users, known as an “inode”. An inode is a contraction of “index node”, and an inode number identifies a particular inode. The inode of a file contains certain attributes of the file, typically the length of the file in bytes, an identifier of the device containing the file, the user ID (identifier) of the file's owner, the group ID of the file, a mode that determines certain user privileges for accessing the file, access and modification timestamps, a reference count that states the number of links pointing to the inode, and pointers to disk blocks that store the file's content.

In Unix, an inode number is an index into a table of inodes in a known location on a device. From the inode number, the Unix kernel can access the contents of the inode, including the data pointers, and thereby retrieve or modify the contents of the file. The Unix system maintains a lookup table for each directory that keeps the inode numbers and the file names of all the direct members of the directory.

The inode, however, lacks the name of the file, and the access path to the file. As noted above, both of these are needed for efficient operation of the system 10. Inode numbers, however, are readily available in Unix. Indeed, the ordinary shell command “ls−i” returns inode numbers of files.

When a process refers to a file by name, the Unix kernel parses the file name one component at a time, checks that the process has permission to search the directories in the path and eventually retrieves the inode for the file. When the operating system receives a new file access request as a file name, it converts the filename to an inode number at the first opportunity, and then discards the file name. From the inode number, the kernel can access the file content. In general, if a path name starts from the root directory, then the kernel assigns the root inode as a working inode, otherwise, the kernel assigns the current directory inode as the working inode. While there are more path names to evaluate, the kernel reads the next path name component from input and searches the current working inode to find a file with an inode matching the filename. This inode becomes the working inode. The process continues until all components of the path name have been processed. The final inode determined in the process is the inode of the needed file.

While the access path can be derived from an inode number by a somewhat circuitous method, this degrades the performance of the system 10, and has been a limiting factor in some UNIX-based systems. For example, it would be possible to obtain the full access path, i.e., the path and file name, by searching a directory system, and obtaining the inode number of each file until a match with the desired inode number is discovered. The full access path of the file is then known.

There are currently several ways to accomplish the target of finding the path-name of a given inode number:

1. In a pre-processing step one can crawl over all the files in the system and maintain a lookup table that provides for each inode its corresponding full path name. In order to convert an inode number to a file name, one can simply perform a table lookup. One difficulty with this approach is that there is a large storage requirement to store the inode numbers of all the files. An even greater problem, however, is that crawling is a very time consuming process and must be repeated from time to time in order to maintain coherence with additions and deletions in the files.

2. Given a list of inode numbers, one can crawl through the file system in a post-processing step, and search for the path-names of these inodes. This can be done at convenient times, e.g., at the end of the day, week etc. This method is also based on a time consuming crawling over the entire storage but there is no need for maintaining a huge inode table. The drawback of this method is that a file can be removed and disappear in the time interval between the inode collection and the crawling.

A number of utilities operate by performing this search or crawl, e.g., GNU locate, available from GNU.org. Some of these utilities maintain tables of inode numbers and access paths could. However, as noted above, the need for updating these tables may impair the accuracy of the collected data or impose an unacceptable burden on the filer.

### Probe Engine.

The probe engine 22 is a monitor program that detects file accesses by users, and, monitors ongoing kernel activities. More specifically, the probe engine 22 monitors and logs current access events that are being processed by the kernel, including the operation of converting a pathname into an inode number. In this manner, concurrent knowledge of the path name of the file and the inode number are known to the probe engine 22. Furthermore, all file attributes contained in the inode and the identity of the user performing the access become available to probe engine 22. The system 10 then records and analyzes the information for its own purposes.

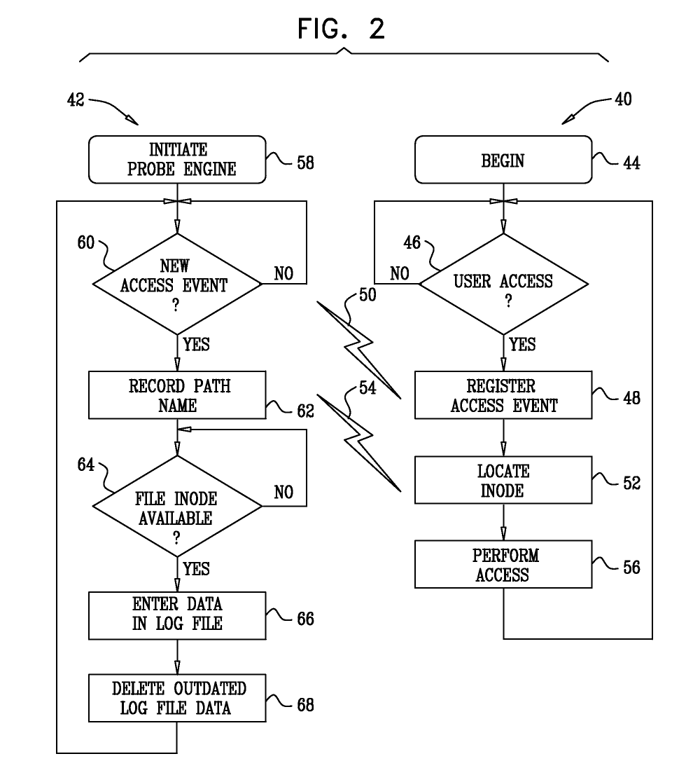

Reference is now made to FIG. 2, which is a flow chart of a method of monitoring file access operations to obtain a path name of a file and an inode number in accordance with a disclosed embodiment of the invention. Two processes, kernel process 40 and probe engine process 42 are executing concurrently in each filer of a file system. The steps in the processes 40, 42 are shown in a particular linear sequence in for clarity of presentation. However, it will be evident that many of them can be performed in parallel, asynchronously, or in different orders. For example, in kernel process 40 many new user access requests may be detected before an older user access request is fully processed. Different implementations of the processes 40, 42 will occur to those skilled in the art in order to support concurrency and deal efficiently with a high transaction volume.

Kernel process 40, shown at the right side of FIG. 2, is an operating system process, typically the Unix kernel, begins at initial step 44. At delay step 46, the kernel process 40 awaits any user access to a storage element of the file system. The implementation of delay step 46 may vary in different Unix variants, and is not critical, so long as the probe engine process 42, at the left side of FIG. 2, can monitor its activity. When a user access request is detected, an indication of the access event is registered at step 48. The indication is represented by a signal icon 50.

Detection of the user access request via the kernel is accomplished by replacement of the function vector used by the kernel with a new vector. The effect is to call the original kernel function as if it was chained. Some operating systems include a built-in framework for such chaining, but some do not. The Solaris operating system, which is employed in a current embodiment, developed an implementation of virtual file system operations (sometimes referred to as mount point operations (VFS_*)) and file operations (also known as node operations (VOP_*)). Such virtual operations have since been adopted by other Unix and Unix-like operating systems. While mount point operations and node operations differ among Unix and Unix-like systems, all essentially dispatch file system calls and file-related calls via virtual function tables. Indeed, the Solaris operations system has further evolved, and now offers virtual operations using a template-based mechanism that can be manipulated in real time. It is even possible to redirect operations to a new interface. For example, one can redirect the command ‘open’ to a custom implementation, which in addition to actually performing the file open request, also logs the event. The conversion of the file description from a path into an inode is done using the Unix command lookup( ). In this manner, step 48 is performed by redirection of file access commands so as to log the path to a file during an inode conversion event.

Listing 1 exemplifies redirection of basic file access commands in step 48, (e.g., open, read) into a custom implementation of the commands. Redirection function Redirect_FileSystem( ) redirects every file access request, e.g., open( ), to a user-defined routine. The user-defined function varonis_vop_open( ), dealing with opening a file, and shown in Listing 1 illustrates this representatively. The user-defined routine, in addition to performing the requested command logs the event. Thereafter, a call to the function Re-store_FileSystem( ) restores the original state of command implementation. Other well-known virtual file system (VFS) functions may be invoked to provide details such as the inode number of an inode being accessed and the path of the file itself. The actual results, i.e., the path name and inode number are obtained using the function lookup( ), which has been redirected as the function vop_lookup.

At this point the user identification and path name of the desired file are known to the kernel process 40, and, as explained below, are detectable by the probe engine process 42. The kernel process 40 then proceeds to locate the inode of the file being accessed at step 52. When the inode is found, an indication of its inode number, represented by a signal icon 54 is detectable by the probe engine process 42.

Next, at step 56 the kernel performs the requested file access conventionally. Control then returns to delay step 46 for another iteration.

Probe engine process 42 is a monitor program that observes activities of a computer operating system, e.g., the kernel process 40. The probe engine process 42 is initiated at initial step 58. Control then proceeds to delay step 60, where an indication of a new user access is awaited by monitoring kernel process 40 (signal icon 50).

When a new access event is detected in delay step 60, the path name of the file being accessed is obtained from the kernel and memorized in step 62.

Next, at delay step 64, the identification of the file's inode number by the kernel is awaited. When the event in which the kernel has made the identification is detected (signal icon 54), at step 66 a log file entry is completed. This entry comprises at least the inode number, the path name of the file, and a time stamp or indication of the entry's time-to-live. Alternatively, a time stamp may be written periodically into the log file, which may conserve storage under conditions of high transaction volume. An exemplary set of log entries is shown in Table 1.

TABLE 1

| | | | | |
|---|---|---|---|---|
| ts: 955216 | op: OP_CREATE_DIR | uid: 0(g: 0) | inode: 2 | path: myDirts |
| ts: 955285 | op: OP_CREATE | uid: 0(g: 0) | inode: 2 | path: myfile.txt |
| ts: 955285 | op: OP_OPEN | uid: 0(g: 0) | inode: 5 | path: --> |
| | | | | myfile.txt ( |
| | | | | pInode: 2 ) |
| ts: 955285 | op: OP_WRITE | uid: 0(g: 0) | inode: 5 | path: --> |
| | | | | myfile.txt ( |
| | | | | pInode: 2 ) |
| ts: 955305 | op: OP_LOOKUP | uid: 0(g: 0) | inode: 2 | path: myfile.txt == |
| | | | | inode: 5 |
| ts: 955306 | op: OP_SET_SEC | uid: 0(g: 0) | inode: 5 | path: --> |
| | | | | myfile.txt ( |
| | | | | pInode: 2 ) |
| ts: 955306 | op: OP_LOOKUP | uid: 0(g: 0) | inode: 2 | path: myfile.txt == |
| | | | | inode: 5 |
| ts: 955317 | op: OP_OPEN | uid: 0(g: 0) | inode: 5 | path: --> |
| | | | | myfile.txt ( |
| | | | | pInode: 2 ) |
| ts: 955317 | op: OP_READ | uid: 0(g: 0) | inode: 5 | path: --> |
| | | | | myfile.txt ( |
| | | | | pInode: 2 ) |

legend:
ts—timestamp,
op—data access operation,
uid—use identification,
inode—inode number,
path—pathname

Next, at step 68, the log file is inspected for outdated entries, which are deleted. As explained below, it is desirable to prevent the log file from growing too large, in order to facilitate searching the log file. It has been found that storage on the order of 25 Mb is an acceptable tradeoff between minimization of storage and retaining sufficient data to allow identification of recently accessed files. Control then returns to delay step 60 to await a new access.

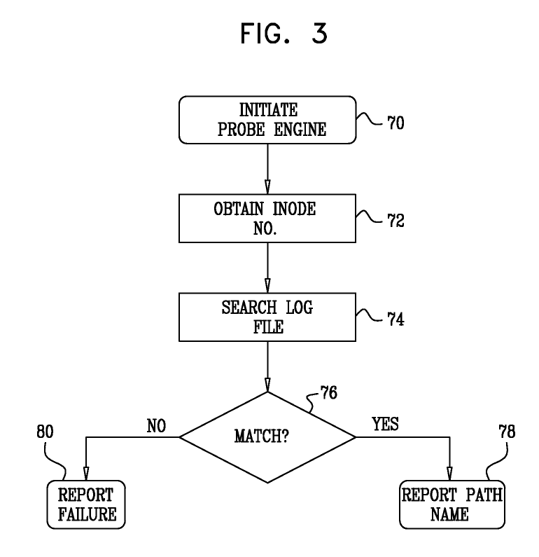

Reference is now made to FIG. 3, which is a flow chart of a method of back-resolving an inode number in accordance with a disclosed embodiment of the invention. At initial step 70, the probe engine process 42 (FIG. 2) is initiated, and a log file is assumed to now be available. Next, at step 72, an inode number is obtained during routine operation of the system 10 (FIG. 1). For example, the system 10 is adapted to monitoring user access privileges on files in the file system. For reasons of efficiency, the system 10 may evaluate recently accessed files, e.g., in off-line or batch mode, by direct inspection of inode data. As explained above, the inode data lacks the corresponding path name of the file that it describes.

Determining a path name given an inode number now reduces to a search of the log file of the above-described monitoring information, which is performed at step 74.

Control now proceeds to decision step 76, where it is determined if an entry in the log file includes a match with the inode number obtained in step 72.

If the determination at decision step 76 is affirmative, then control proceeds to final step 78. The path name in the log file entry found in decision step 76 is reported.

If the determination at decision step 76 is negative, then control proceeds to final step 80. Failure is reported. Once the inode number is found, there is minimal latency in retrieving the corresponding path name from the log file.

### Alternate Embodiment 1

In this embodiment, the requirement for continually monitoring the kernel is unnecessary. Some variants of Unix and Unix-like operating systems are not conducive to probes of kernel operations. Instead, a lookup table, limited to a directory tree and corresponding directory inode numbers is prepared off-line.

Then, given an inode number of a file that needs to be associated with a full path name, the parent directory's inode number is obtained as described above. The parent directory's inode number is then matched with an entry in the table. The full path name is available in the entry.

While it is necessary to crawl through the file system and maintain a lookup table for all the directories, the number of directories in a typical filer is generally much less than the number of files. Hence, crawling can be performed relatively quickly, and the required storage for the directory lookup table is relatively small.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

COMPUTER PROGRAM LISTINGS
Listing 1

```
Redirect_FileSystem( filesystem ) {
  Save Vops into OrigVops
  Filesystem.Vops.vop_open = varonis_vop_open;
  Filesystem.Vops.vop_lookup  = varonis_vop_lookup;
  Filesystem.Vops.vop_close  = varonis_vop_close;
  ...
}
Int varonis_vop_open(  args  -  original Vop function
arguments ) {
  res = OrigVops.vop_open(  args  );
  Log(  Open,  args );
  Return res;
}
Int varonis_vop_lookup(  args  -  original Vop function
arguments ) {
  res = OrigVops.vop_lookup( args );
  Log( lookup, args );
  Return res;
}
Restore_FileSystem( filesystem) {
  Filesystem.Vops.vop_open = OrigVops.vop_open;
  Filesystem.Vops.vop_lookup  = OrigVops.vop_lookup;
  Filesystem.Vops.vop_close  = OrigVops.vop_close;
  ...
}
```

1. A method of monitoring data accesses in a computer system, comprising the steps of:
concurrently executing a monitor program and a kernel program, said kernel program servicing requests for data accesses in a file system, said file system comprising index nodes that respectively index descriptors of computer files;
detecting in said kernel program a request for access to one of said computer files, said request comprising a full path name of said one of said computer files;
using said monitor program, obtaining said full path name;
using said kernel program, processing said request by determining an identifier of one of said index nodes that corresponds to said one of said computer files and executing said request using said identifier;
while performing said step of processing said request, obtaining said identifier using said monitor program;
using said monitor program memorizing said full path name and said identifier as an entry in a log file; and
accessing said log file for analysis of said requests for data access.

2. The method according to claim 1, further comprising the steps of:
identifying in said monitor program an originator of said request; and
including an identifier of said originator in said entry in said log file.

3. The method according to claim 2, further comprising the step of responsively to said step of accessing said log file, modifying privileges of said originator to access said file system.

4. The method according to claim 1, further comprising the steps of:
accepting a second identifier of one of said index nodes;
establishing that said identifier in said entry matches said second identifier;
responsively to said step of establishing retrieving said full path name from said entry; and
reporting said full path name.

5. The method according to claim 1, wherein said index nodes are inodes.

6. The method according to claim 1, wherein said index nodes are vnodes.

7. A computer software product for monitoring file system data accesses, including a computer storage medium in which computer program instructions are stored, which instructions, when executed by a computer, cause the computer to concurrently execute a monitor program and a kernel program, said kernel program servicing requests for data accesses in a file system, said file system comprising index nodes that respectively index descriptors of computer files, detect in said kernel program a request for access to one of said computer files, said request comprising a full path name of said one of said computer files, using said monitor program, obtain said full path name, using said kernel program, process said request by determining an identifier of one of said index nodes that corresponds to said one of said computer files and executing said request using said identifier, and said instructions further cause said computer to obtain said identifier with said monitor program while processing said request, memorize said full path name and said identifier as an entry in a log file, and access said log file for analysis of said requests for data access.

8. The computer software product according to claim 7, wherein said instructions further cause said computer to identify an originator of said request using said monitor program, and include an identifier of said originator in said entry in said log file.

9. The computer software product according to claim 8, wherein said instructions further cause said computer to modify privileges of said originator to access said file system responsively to said entry in said log file,.

10. The computer software product according to claim 7, wherein said instructions further cause said computer to accept a second identifier of one of said index nodes, establish that said identifier in said entry matches said second identifier, retrieve said full path name from said entry, and report said full path name.

11. The computer software product according to claim 7, wherein said index nodes are inodes.

12. The computer software product according to claim 7, wherein said index nodes are vnodes.

13. A data processing system for monitoring file system data accesses, comprising:
a processor; and
a memory accessible to said processor that stores a monitor program and a kernel program, said processor operative to concurrently execute said monitor program and said kernel program, said kernel program servicing requests for data accesses in a file system, said file system comprising index nodes that respectively index descriptors of computer files, said processor is operative to detect in said kernel program a request for access to one of said computer files, said request comprising a full path name of said one of said computer files, using said monitor program, obtain said full path name, using said kernel program, process said request by determining an identifier of one of said index nodes that corresponds to said one of said computer files and executing said request using said identifier, and said processor is operative to obtain said identifier with said monitor program while processing said request, memorize said full path name and said identifier as an entry in a log file, and access said log file for analysis of said requests for data access.

14. The data processing system according to claim 13, wherein said processor is operative to identify an originator of said request using said monitor program, and include an identifier of said originator in said entry in said log file.

15. The data processing system according to claim 14,
further comprising a display linked to said processor, wherein said processor is operative to output at least a portion of said log file to said display; and responsively to said entry in said log file, modify privileges of said originator to access said file system.

16. The data processing system according to claim 13, wherein said processor is operative to accept a second identifier of one of said index nodes, establish that said identifier in said entry matches said second identifier, retrieve said full path name from said entry, and report said full path name.

17. The data processing system according to claim 13, wherein said index nodes are inodes.

18. The data processing system according to claim 13, wherein said index nodes are vnodes.
